(19) United States
(12) Patent Application Publication
(10) Pub. No.: US 2005/0053767 A1
(43) Pub. Date: Mar. 10, 2005

(54) Extruded wood imitation component and process

(76) Inventors: Sandro Franco, Montreal (CA); Carmine Franco, Montreal (CA)

Correspondence Address: OGILVY RENAULT, 1981 MCGILL COLLEGE AVENUE, SUITE 1600, MONTREAL, QC, H3A2Y3, CA

(21) Appl. No.: 10/941,865

(22) Filed: Sep. 16, 2004

Related U.S. Application Data
(63) Continuation of application No. 10/277,902, filed on Oct. 23, 2002.

(30) Foreign Application Priority Data
Aug. 21, 2002 (CA) 2,399,354

(51) Int. Cl. B32B 1/00

(52) U.S. Cl. 428/151

(57) ABSTRACT

An extruded wood imitation component and process is described. The component has a solid core containing coloured polymer material formed from a mix of coloured thermoplastic polymer with veins of contrasting coloured polymer throughout the core and on outer surfaces of the component simulating natural wood. In the extrusion process the mixture includes coloured polymer pellets of different colours and sizes which are mixed and melted in an extruder under controlled conditions to provide contrasting streaks of molten polymer throughout a molten extruded core and on outer surfaces of the core of the extrudate which exits the land of the die.

### CROSS-REFERENCE TO RELATED APPLICATION

This application is a Continuation of Application Ser. No. 10/277,902, filed on Oct. 23, 2002.

### TECHNICAL FIELD

The present invention relates to an extruded wood imitation component formed of coloured thermoplastic polymer material and having contrasting coloured polymer-veins throughout the core and outer surfaces of the component whereby to simulate natural wood. The invention also relates to the extrusion process of the fabrication of the wood imitation components.

### BACKGROUND ART

There are a multitude of synthetic products or composite products that imitate natural wood. These are formed by various methods such as extrusion and embossing or by injection in a mold containing patterns etched in the surfaces of the mold. Some products are also laminated with surface coverings, with the covering having a printed pattern to simulate wood or other materials such as marble, etc. Wood imitation is also obtained by painting or staining the surface of a core product to imitate a wood grain and wood colour. In such painting and staining process, thermoplastic materials do not play a great role in the appearance of the product as the extrusion part of the process is a conventional one. This means that one would seek as much mixing of the polymers as possible in order to achieve a good melting and a homogeneous temperature in the molten polymer. The only limitation for mixing is thermomechanical degradation of the polymer material.

A more popular method of imitation wood is by simulating wood grain on a plastic core. The process includes a foil paper which wraps a core and transfers ink from the paper onto the plastic by a lamination process. Prior technologies include co-extruding a layer around the plastic core to imitate wood. These processes are somewhat complicated due to having multiple steps involved to achieve a wood look. The final products are not stable to ultraviolet exposure and when the product is cut, the cut end or part must be stained or painted to conceal the different material colour. Common products made of ABS or polystyrene also tend to turn yellow and crack. They also chip during cutting.

There is a need to produce louvers for window blinds using an extrusion process. Examples of these processes are described in U.S. Pat. Nos. 5,996,672 and 6,083,601, as examples. In the first one of these examples a wooden core is wrapped with a flexible film of foil, paper or the like with the film bonded to the core with a polyurethane reactive hot melt adhesive that provides a moisture barrier around the core. Accordingly, this product requires lamination and is more costly to fabricate. When the wrapping is scratched, it exposes the core and the scratch is very visible and cannot be repaired. In the other patent, the extruded product has a foam core formed of a blend of powdered cellulose with a base resin and an oxidizer. A protective cladding is coaxially extruded around the core of the extrudable mixture to form an elongated product having a foam core which is at least partly enclosed by a protective cladding. This composite product also has the disadvantages as above-mentioned.

Another disadvantage of laminated prior art wood imitation components is that the outside lamination usually contains a repeat pattern which is quite visible to the eye and reveals the fact that the product is an imitation and not real.

There is a need to provide an extruded wood imitation component which is a solid core which closely resembles natural wood and when cut it exposes a solid material that does not contrast with the overall appearance of the component and wherein the veining in the product extends within the core and on the surfaces in a random non-repetitive manner.

### SUMMARY OF INVENTION

It is a feature of the present invention to provide an extruded wood imitation component and extrusion process which simulates natural wood throughout the core of the component.

Another feature of the present invention is to provide an extruded wood imitation component containing embossment on outer surfaces thereof to provide wood texture and wherein the outer surfaces have contrasting coloured veins to simulate wood grain with the veins extending into the core.

Another feature of the present invention is to provide an extruded wood imitation component containing a solid core of coloured polymer material mixed with wood particles to provide texture resembling real wood on the outer surfaces of the component.

According to the above features, from a broad aspect, the present invention provides an extruded wood imitation component comprising a solid core containing a mix of coloured thermoplastic polymer material and having veins of contrasting coloured polymer throughout the core and on outer surfaces of the component to simulate natural wood.

According to a still further broad aspect of the present invention there is provided an extrusion process for the fabrication of wood imitation components. The process comprises the steps of providing a mixture of thermoplastic polymer material having pellets selected to form an extruded component to simulate a natural wood component. There being groups of different coloured pellets and pellets of different sizes in the mixture. The larger ones of the pellets have one or more colours to contrast with the colours of the other pellets. The mixture of coloured polymer pellets are fed in an extruder, melted and mixed along the extruder wherein larger pellets take a longer time to melt to provide contrasting streaks of molten polymer throughout a molten extruded core and on outer surfaces of the core exiting from a land of a die of the extruder.

### BRIEF DESCRIPTION OF DRAWINGS

A preferred embodiment of the present invention will now be described with reference to the accompanying drawings in which:

FIG. 1 is a perspective fragmented view of a flat louver component fabricated in accordance with the extrusion process of the present invention;

FIG. 2 is a cross-sectional schematic illustration of the extruder utilized in the extrusion process of the present invention for the fabrication of wood imitation components; and

FIG. 3 is a simplified diagrammatic side view of the apparatus used in the process of fabrication of the extruded wood imitation components of the present invention.

### DESCRIPTION OF PREFERRED EMBODIMENTS

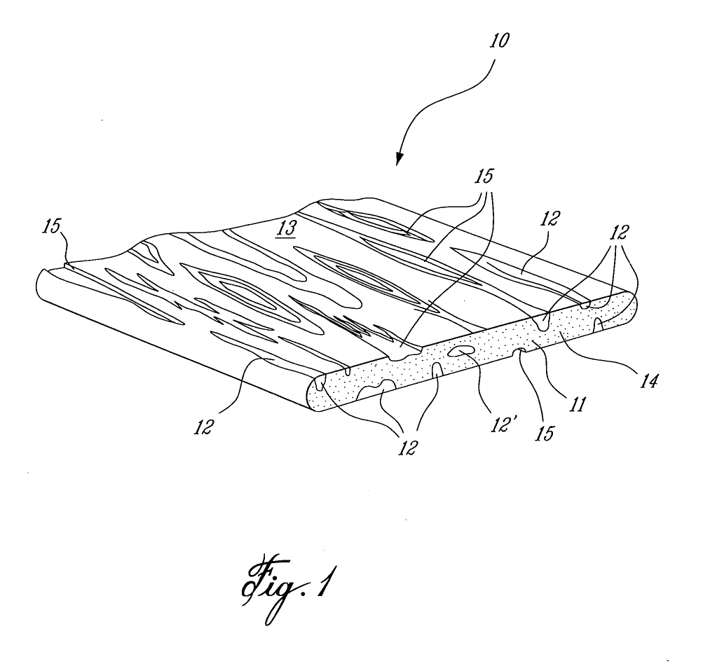

Referring now to FIG. 1, there is shown generally at 10 an extruded wood imitation component fabricated in accordance with the extrusion process of the present invention. The component 10 is a solid core of coloured polymer material formed from a mix of coloured polymer pellets whereby to produce veins 12 of contrasting coloured polymer throughout the core and on outer surfaces 13 of the component 10 whereby to simulate natural wood. As hereinshown, the veins 12 of contrasting coloured polymer are streaked along the longitudinal axis of the component and some of these veins such as that identified by reference numeral 12′ may be located entirely within the solid core 11. Accordingly, if the core was to be grounded on its outer surfaces 13, it would continue to expose further veining to simulate the same overall appearance and colour of the component but with a different vein effect similar to natural wood. Also, with the component of the present invention, when the component is cut, it exposes a cut surface such as the end surface 14 and that surface is formed of the same polymer mix as appearing on the outer surfaces and is of the same colour with contrasting coloured veins. It is therefore not necessary to paint such exposed end surfaces. Thus, the extruded wood imitation component 10 of the present invention is a solid single piece component and does not require lamination or painting to imitate natural wood.

As can also be seen in FIG. 1, the component 10 may also comprise embossments 15 on its outer surfaces to provide a wood texture in said surfaces but this is not an essential requirement of the present invention.

The coloured thermoplastic polymer material, such as PVC (polyvinyl chloride) material which has fire retardant properties. Accordingly, these components are highly desirable for the construction industry for the fabrication of flat louvers as illustrated in FIG. 1 or decorative valances or bottom rails for use in the construction of Venetian blinds. Of course, there are several other applications too numerous to mention such as the production of drapery poles, woven woods, decking or flooring boards, boards for fencing, decorative moldings, picture framing, window styles, tables, automobile trims, etc. This type of product has many desirable characteristics such as being resistant to humidity and heat, therefore being suitable for indoor and outdoor applications. The material also does not chip when cut and has a high impact strength. It also has superior dye-lot consistency between production batches which is a great advantage over wood blinds, as an example. The material is also resistant to UV, is dimensionally stable, does not crack or scratch and requires no maintenance and is very easy to clean when necessary to do so.

It is also to be noted that the veins 12 are of random shape throughout the extruded component and there is no repeat of any pattern, thereby simulating natural wood. The coloured polymer material can also be mixed with wood particles and/or cellulosic fibers whereby to increase graining effect on the outer surfaces 13 and end surfaces 14. These wood particles may be provided in quantities of from about 3 percent to 40 percent of the solid core. The wood particles could range in aspect ratio from 1 to 65 and in size from about 15 to 500 microns. The solid core 11 may also contain from about 1 percent to 7 percent of foaming agent and this would make the component lighter in weight.

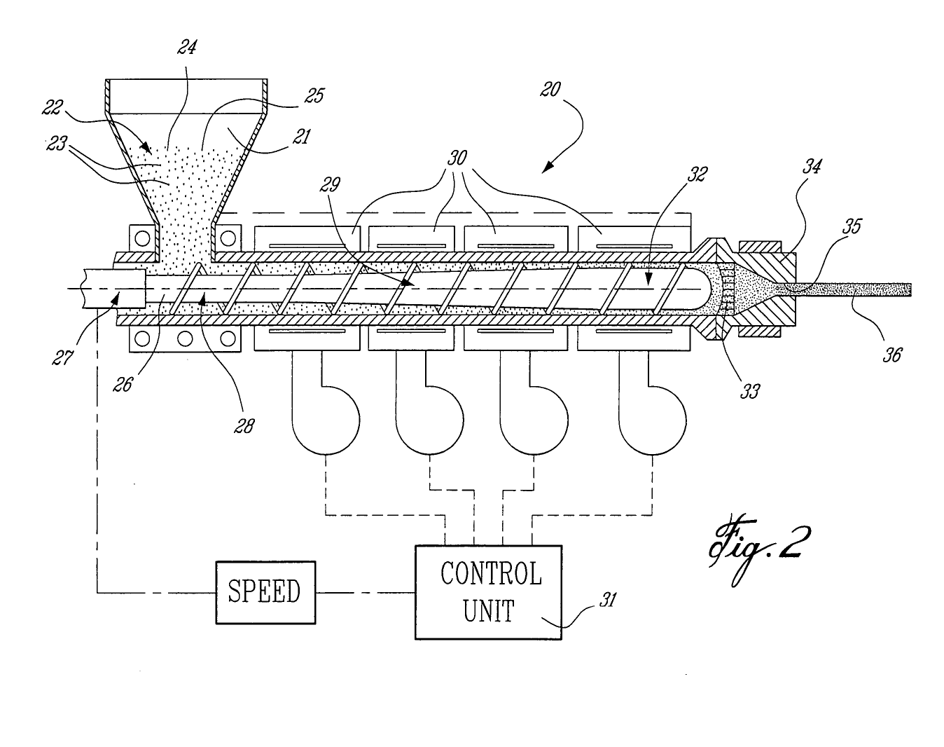

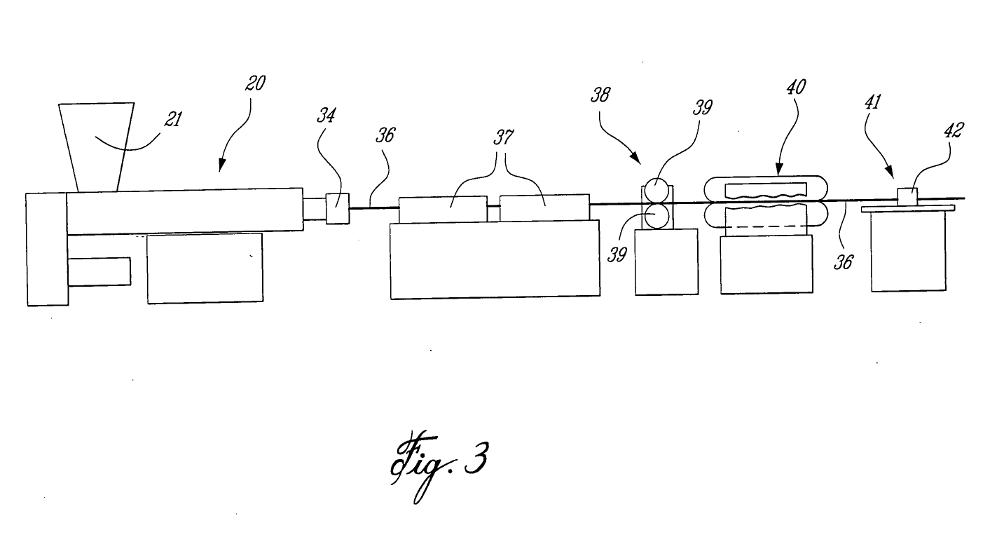

Referring now to FIGS. 2 and 3, there will be described in more detail the extrusion process for the fabrication of the wood imitation component 10 as shown in FIG. 1. However, before describing these Figures, some important aspects of the present invention will be described. First, raw material is provided by thermoplastic pellets. Pellets of different colour and different sizes are pre-mixed prior to the extrusion process. Not less than two different colours are used to achieve a desired wood simulation. There is no limitation in the number of colours to be pre-mixed and the dark coloured carrier particles are usually larger whereby to provide contrasting streaks of different sizes and shapes. Powder and re-ground material can also be used as base colour. They can also be used as a dark colour but depending on their particle size, they will render a different effect. Different grade and/or molecular weight of the same material can be used to influence the level of mixing and the appearance of the final product.

Pellets can also be of different material. If that is the case, the level of miscibility and the viscosity ratio become other parameters to control the aspect of the final product. Foaming agents can also be used. Then the part surface density will affect colours. It becomes another parameter to control but it reduces the windows of operation because foaming agents need to be metered very carefully. The visual aspect of the component can be improved by introducing wood particles or cellulosic fibers in the raw material, as above-described. It increases the graining effect and renders a more natural look. Slipping agent can then be used to facilitate the incorporation of wood particles. Particles size is also important wherein small particles result in a shiny surface and coarse particles result in a more natural look and feel on the surface.

Before describing the process as illustrated in FIG. 2, it is also to be noted that equipment design is an important aspect of the process of the present invention. As opposed to standard extrusion where more mixing is better, the process of the present invention relies on carefully controlled mixing. However, this should not impede proper melting of the thermoplastic. Mixing is often separated in dispersive and distributive mixing. Dispersive mixing relies mainly on shear but in the present process shear needs to be limited especially early in the process in the extruder. Mixing heads are also not recommended and particularly Maddock type or any other high shear mixing heads are incompatible with the process of the present invention.

Shear mixing in the breaker plate and the die is important to produce long veins instead of spots in the extruded core. In the die, shear is more important in the land area. The length of this area needs to be adjusted to produce the proper effect. However, longer land yields higher pressure for the same flow rate. This results in more shear mixing in the screw. Therefore, the two effects need to be optimized and parts having larger sections may require a mandrel or a constriction to achieve the proper veining effect.

Distributive mixing relies mainly on flow separations. These separations occur when the molten polymer flows around mixing pins on the screw, through the many holes of the breaker plate and around a mandrel and its lengths. The mandrel is held in place by spider legs. In the present invention it is an important feature because it generates more streaks and veins. Mixing needs to be controlled within a certain range to produce the desired effects.

Process conditions for the process of the present invention are barrel and die temperature profiles and screw speed. Since mixing is critical, barrel temperatures are important to fine-tune the level of mixing. Lower temperature in the upstream zones will slow melting and diminish mixing. Higher temperatures in the downstream zone will increase polymer melt temperature, lower its viscosity and facilitate mixing. It will also affect foaming if foaming agents are used. It can therefore be appreciated that careful control over all three parameters, namely, raw material, equipment design and process conditions, enables the process of the present invention to produce and control the visual aspect of the extruded component to duplicate veins, grain and colours of natural wood.

With reference now to FIG. 2, there is shown generally at 20 the screw extruder provided at the front end of the complete process as illustrated in FIG. 3. The screw extruder has a hopper 21 in which a mixture 22 including PVC pellets 23, foaming agents 24 and wood particles 25 is placed. Of course, the materials may be introduced at proper locations along the extruder barrel by using several hoppers. These pellets and agents and wood particles have been pre-mixed when disposed in the hopper. This mixture may have a viscosity varying from about 400 up to about 7000 Pa at a shear rate of 100 reciprocal second. As the mixture 22 is fed into the feed end 26 of the screw 27, they are first compressed in a solid conveying zone 28 to form a solid bed. The screw 27 is designed for low shear and high transport. As the pellets are displaced from the feed end 26, they melt all along the melting zone 29. The entire barrel or extruder is provided with several temperature zones 30, the temperature of which is controlled by a control unit 31′.

As the mixture of pellets 22 melt, as they are conveyed along the melting zone 29, the molten pellets are being mixed through the shearing effect from the flow recirculation occurring aside the solid bed. Larger pellets take longer to melt, thus receive less mixing. This results in larger and longer streaks. Once melted, pellets made with higher viscosity material will be more difficult to mix and this produces larger and longer streaks of the coloured polymer, but it also improves streaks definition and contrast. Higher barrel temperatures will accelerate the melting process and give more time for mixing. This will reduce streak intensity and number because some will vanish completely.

Molten polymer then continues into the final metering section 32 of the screw extruder where more mixing takes place. This is the zone having the greatest influence on polymer melt temperature. Higher melt temperature will increase foaming and mixing in that zone and subsequently in the breaker plate 33 and die 34. Typical melt temperature varies from about 148° C. up to 186° C. At the end of the extruder, the flow passes in the breaker plate which is essentially a screen for filtration and mixing purpose before it is split into many holes. This flow separation will split streaks and lengthen them along the extruded component.

Finally, the molten polymer enters the adapter and die. The function of the die is to shape the material into the proper shape and ensure even flow distribution. The final portion of the die is called the land 35 and this is the thinnest portion and least shearing mixing section of the extruder. Streak shapes are set in that section. The extrudate 36 exiting the die is then further processed as shown in FIG. 3.

With reference to FIG. 3, it can be seen that after the extrudate 36 exits the land 35 of the die 34, it goes through a series of water-cooled calibrators 37. Veining is then complete but the cooling will influence surface finish. More intense cooling will produce a shiny surface and a slower will produce a dull surface on the extrudate 36. The extrudate may then go through an embossing station 38 where at least one surface of the extrudate or as hereinshown both surfaces are embossed by embossing rolls 39 disposed on opposed sides of the extrudate and rotated against the surfaces so as to impress a pattern in the extrudate. This embossed pattern enhances the coloured veins in the extruded part.

The extrudate after having been embossed, if that is the case, then goes through the puller 40 and on to a cutting station 41 which has a cutting head 42 to cut the extrudate in desired lengths. As previously described, this cutting head will provide a sharp cut exposing, the material core which is the same colour as the surfaces of the product of the component and will not chip the end edges of the cut product.

Summarizing the extrusion process, there is first provided a mixture of thermoplastic polymer material including pellets selected to form an extruded component to simulate a natural wood component. There are groups of different coloured pellets and pellets of different sizes in the mixture. Large ones of the pellets have one or more colours to contrast with the colours of others of the pellets. This mixture is then fed into the hopper of an extruder and convected therein through melting and mixing zones wherein larger pellets take a longer time to melt to provide contrasting streaks of molten polymer throughout the extrudate and on the outer surfaces of the extrudate which exits the land of the die. The mixture may include wood particles as well as foaming agents depending on the desirable characteristics of extrudate and component made therefrom. Wood particles introduced into the mixture would have a moisture content not exceeding 20 percent and an aspect ratio of about 1 to 65.

Examples of polymer pellet mixtures to produce different natural wood components are disclosed in Tables 1 and 2 hereinbelow.

TABLE 1
Composition of Larice 21

| | | pellet length mm | |
|---|---|---|---|
| Color | % w/w | Min | Max |
| C100 | 1.5% | 2 | 4 |
| C101 | 2.0% | 1 | 5 |
| C102 | 6.0% | 1 | 6 |
| C103 | 7.5% | 1 | 6 |
| C104 | 23.0% | 3 | 5 |
| C105 | 60.0% | 3 | 5 |
| | 100.0% | | |

TABLE 2
Composition of Mogano 19

| | | pellet length mm | |
|---|---|---|---|
| Color | % w/w | Min | Max |
| C102 | 6.5% | 1 | 6 |
| C106 | 66.5% | 3 | 5 |
| C107 | 27.0% | 2 | 6 |
| | 100.0% | | |

Table 3 shown hereinbelow gives an example of the specific control parameters of the extruder for producing the component such as shown in Tables 1 and 2. However, it is to be understood that depending on the size of the component to be extruded, the veining effect and colour effect to be produced, that these parameters may vary for different components to be extruded.

TABLE 3
Process conditions

| | |
|---|---|
| Speed | |
| Screw speed | 8 to 30 rpm |
| Line speed | 4 to 25 feet per minute |
| Temperature | |
| Barrel zone 1 | From 100 to 170 C. |
| Barrel zone 2 | From 120 to 175 C. |
| Barrel zone 3 | From 140 to 180 C. |
| Barrel zone 4 | From 140 to 180 C. |
| Adapter | From 140 to 180 C. |
| Die | From 140 to 180 C. |

It is within the ambit of the present invention to cover any obvious modifications, provided such modifications fall within the scope of the appended claims.

1. An extruded wood imitation component comprising a solid core containing a mix of different coloured thermoplastic polymer material which produce veins of irregular lengths and shapes of contrasting colour throughout said core and on all outer surfaces of said core whereby said core and outer surfaces are of identical colouration to simulate natural wood throughout, said coloured polymer material being comprised by a mixture of similar polymer material pellets of different colours some of said pellets being of different size whereby to melt slower during extrusion to produce said contrasting veins.

2. A component as claimed in claim 1 wherein at least one of said outer surfaces has an embossment thereon to provide a wood texture on said surface.

3. A component as claimed in claim 1 wherein said coloured thermoplastic polymer material is polyvinyl chloride material, said component having fire retardant properties.

4. (cancelled)

5. (cancelled)

6. A component as claimed in claim 1 wherein there are at least two different coloured groups of said pellets.

7. A component as claimed in claim 3 wherein said polyvinyl chloride material is mixed with wood particles to increase graining effect on said outer surfaces.

8. A component as claimed in claim 3 wherein said polyvinyl chloride material is mixed with cellulosic fibers.

9. A component as claimed in claim 1 wherein said component is one of a flat louver, a decorative valance and a decorative bottom rail for the construction of a Venetian blind.

10. A component as claimed in claim 7 wherein said wood particles are provided in quantities of from about 3 percent to 40 percent of said solid core.

11. A component as claimed in claim 10 wherein said solid core also contains from about 1 percent to 7 percent of foaming agent.

12. A component as claimed in claim 10 wherein said wood particles range in aspect ratio from 1 to 65 and in size from about 15 to 500 microns.

13. (cancelled)

14. (cancelled)

15. (cancelled)

16. (cancelled)

17. (cancelled)

18. (cancelled)

19. (cancelled)

20. (cancelled)

21. (cancelled)

22. (cancelled)
